(19) United States
(12) Patent Application Publication
(10) Pub. No.: US 2023/0204864 A1
(43) Pub. Date: Jun. 29, 2023

(54) SECURING STRUCTURE, OPTICAL DEVICE, AND LASER APPARATUS

(71) Applicant: Fujikura Ltd., Tokyo (JP)

(72) Inventor: Tomohisa Endo, Chiba (JP)

(73) Assignee: Fujikura Ltd., Tokyo (JP)

(21) Appl. No.: 18/008,242

(22) PCT Filed: May 12, 2021
(86) PCT No.: PCT/JP2021/018038

§ 371 Date: Dec. 5, 2022

(30) Foreign Application Priority Data
Jul. 1, 2020 (JP) 2020-114282

(51) Int. Cl. G02B 6/36

(52) U.S. Cl. CPC G02B 6/3616; G02B 6/3636

(57) ABSTRACT

A securing structure includes: an optical fiber; a support body that includes a first groove that accommodates the optical fiber; and a resin member that, inside the first groove, covers a boundary between a coating section of the optical fiber and a coating-removed section of the optical fiber, and secures the optical fiber to the support body. The resin member spreads out of the first groove partway along the first groove.

### TECHNICAL FIELD

The present invention relates to a securing structure for securing an optical fiber to a support body with use of a resin member. The present invention also relates to an optical device including such a securing structure and relates to a laser apparatus including such an optical device.

### BACKGROUND

A securing structure for securing an optical fiber to a support body with use of a resin member that covers a boundary between a coating-removed section of an optical fiber and a coating section of the optical fiber is widely used. For example, Patent Literature 1 discloses a securing structure for securing an optical fiber to an end portion (equivalent to the above-described support body) with use of a guiding adhesive (equivalent to the above-described resin member) that covers a boundary between a coating-removed section of an optical fiber and a coating section of the optical fiber. Note that the coating section refers to a section where a cladding of the optical fiber is covered with a coating, and the coating-removed section refers to a section where the coating of the cladding is removed and the cladding is uncovered.

### PATENT LITERATURE

### Patent Literature 1

Published Japanese Translation of PCT International Application, Tokuhyo No. 2016-533543

However, in the conventional securing structure, the light that has leaked, in the coating-removed section, from the cladding of the optical fiber to the resin member may enter the coating in the coating section and cause the coating to generate heat. This may cause a decrease in reliability of the securing structure.

### SUMMARY

One or more embodiments of the present invention achieve a reliable securing structure that reduces heat generation which may be caused in a coating in a case where light that has leaked, in the coating-removed section, from the cladding of the optical fiber to the resin member enters the coating in the coating section. One or more embodiments of the present invention achieve a reliable optical device with use of such a securing structure. One or more embodiments of the present invention achieve a reliable laser apparatus with use of such an optical device.

A securing structure in accordance with one or more embodiments of the present invention includes: an optical fiber; a support body in which a groove for accommodating the optical fiber is formed; and a resin member for covering, inside the groove, a boundary between a coating section of the optical fiber and a coating-removed section of the optical fiber and securing the optical fiber to the support body, the resin member being spread out of the groove partway along the groove.

An optical device in accordance with one or more embodiments of the present invention includes a securing structure in accordance with one or more embodiments of the present invention.

A laser apparatus in accordance with one or more embodiments of the present invention includes an optical device in accordance with one or more embodiments of the present invention.

One or more embodiments of the present invention make it possible to achieve a reliable securing structure that reduces heat generation which may be caused in a coating in a case where light that has leaked, in the coating-removed section, from the cladding of the optical fiber to the resin member enters the coating in the coating section One or more embodiments of the present invention make it possible to achieve a reliable optical device with use of such a securing structure. One or more embodiments of the present invention make it possible to achieve a reliable laser apparatus with use of such an optical device.

### BRIEF DESCRIPTION OF THE DRAWINGS

FIG. 1 is a side view illustrating a configuration of an optical device including a securing structure in accordance with one or more embodiments of the present invention.

FIG. 2 is a cross-sectional view illustrating a section A-A′ of the optical device illustrated in FIG. 1.

FIG. 3 is a cross-sectional view illustrating a section B-B′ of the optical device illustrated in FIG. 1.

FIG. 4 is a graph showing a measurement result of power of light that propagates in a backward direction inside a groove in the securing structure illustrated in FIGS. 1 to 3.

(a) of FIG. 5 is a perspective view of a securing structure in accordance with Example and a view illustrating temperature distribution of the securing structure in accordance with the Example. (b) of FIG. 5 is a perspective view of a securing structure in accordance with Comparative Example and a view illustrating temperature distribution of the securing structure in accordance with the Comparative Example.

FIG. 6 is a graph showing a correlation between increases in temperatures of coatings of optical fibers and deviations of the increases, with respect to Example of 5 samples and Comparative Example of 7 samples.

FIG. 7 is a block diagram of a laser apparatus including the optical device illustrated in FIG. 1.

### DETAILED DESCRIPTION

### Configuration of Optical Device

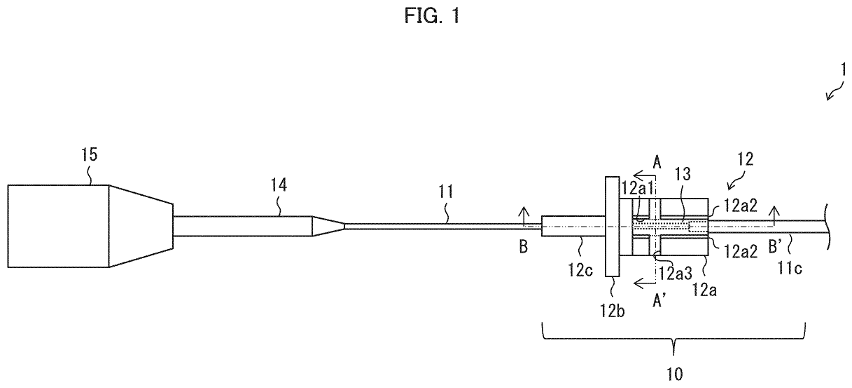

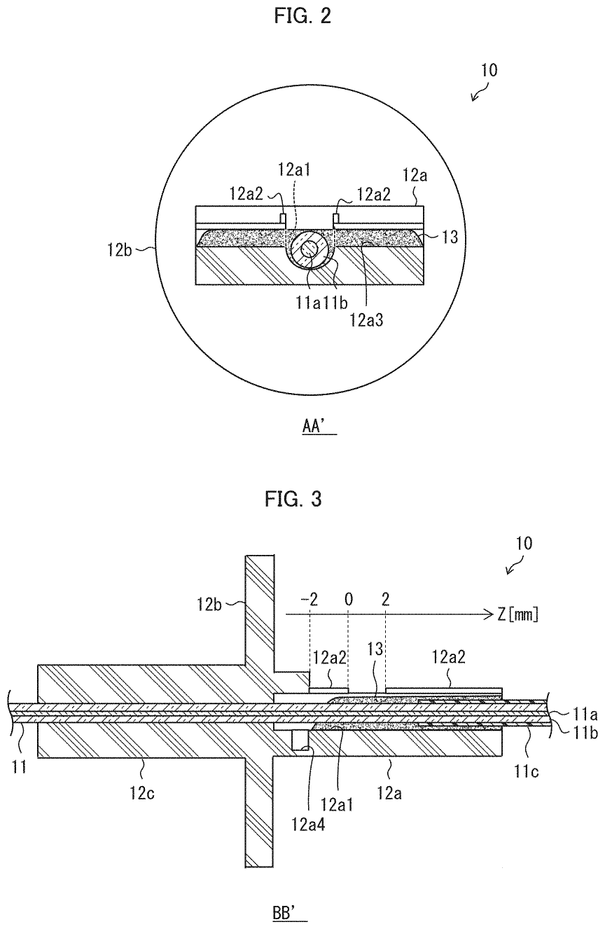

The following will describe an optical device 1 including a securing structure 10 in accordance with one or more embodiments of the present invention with reference to FIGS. 1 to 3. FIG. 1 is a side view illustrating a configuration of the optical device 1. FIG. 2 is a cross-sectional view illustrating a section A-A′ of the securing structure 10 (see FIG. 1). FIG. 3 is a cross-sectional view illustrating a section B-B′ of the securing structure 10 (see FIG. 1).

The optical device 1 is a device for irradiating a workpiece with laser light. As illustrated in FIG. 1, the optical device 1 includes an optical fiber 11, a support body 12, a resin member 13, a large-diameter fiber 14, and a glass block 15. In the optical device 1, the securing structure 10 is constituted by the optical fiber 11, the support body 12, and the resin member 13. Further, the optical device 1 may include a housing (not illustrated). In this case, the housing accommodates the support body 12, the resin member 13, the large-diameter fiber 14, and the glass block 15, and the optical fiber 11 is drawn into the housing.

The optical fiber 11 is a component for guiding laser light. In one or more embodiments, an optical fiber including a core 11a having a circularly columnar shape, a cladding 11b having a cylindrical shape and surrounding the core 11a, and a coating 11c having a cylindrical shape and surrounding the cladding 11b is used as the optical fiber 11. The core 11a and the cladding 11b are made mainly of quartz. The coating 11c is made mainly of resin. The coating 11c is removed in a section including one end of the optical fiber 11. In the optical fiber 11, a “coating section” refers to a section where the cladding 11b is covered with the coating 11c, and a “coating-removed section” refers to a section where the coating 11c is removed and the cladding 11b is uncovered.

The support body 12 is a component for supporting the optical fiber 11 in a linear manner. In one or more embodiments, a support body including a flange portion 12b, a base portion 12a which is provided on one side of the flange portion 12b, and a ferrule portion 12c which is provided on the other side of the flange portion 12b is used as the support body 12. The support body 12 is formed in one piece of copper, and a surface of the support body 12 is plated with gold. The base portion 12a is a plate-like portion having a rectangular main surface. On one surface of the base portion 12a, a groove 12a1 crossing this surface lengthwise and ribs 12a2 disposed on both sides of the groove 12a1 and crossing this surface lengthwise are formed. The optical fiber 11 is accommodated inside the groove 12a1, and is inserted into the ferrule portion 12c via a through hole provided in a center of the flange portion 12b. In this case, the optical fiber 11 is disposed such that a boundary between the coating section of the optical fiber 11 and the coating-removed section of the optical fiber 11 is located inside the groove 12a1.

The resin member 13 is a component for securing the optical fiber 11 accommodated in the groove 12a1 to the support body 12. In one or more embodiments, a resin member obtained by curing a liquid resin that has been injected into the groove 12a1 is used as the resin member 13. The liquid resin may be a photo-curable resin or a heat-curable resin. In a case where the liquid resin is a photo-curable resin, the liquid resin is cured by the irradiation of the liquid resin with light falling within a specific wavelength band (for example, ultraviolet light). In a case where the liquid resin is a heat-curable resin, the liquid resin is cured by the application of heat to the liquid resin.

Laser light emitted from the optical fiber 11 passes through the large-diameter fiber 14 and the glass block 15 and falls on a workpiece. In one or more embodiments, an optical fiber that has a circularly columnar shape and that is tapered down to have a decreased diameter at one end thereof is used as the large-diameter fiber 14, and a glass block that has a circularly columnar shape and that is tapered down to have a decreased diameter at one end thereof is used as the glass block 15. An emission end surface of the optical fiber 11 is fusion-spliced to a smaller diameter-side end surface of the large-diameter fiber 14, and a larger diameter-side end surface of the large-diameter fiber 14 is fused with a smaller diameter-side end surface of the glass block 15.

### Feature of Securing Structure

In the optical device 1, the securing structure 10 includes the optical fiber 11, the support body 12, and the resin member 13. As illustrated in FIGS. 1 and 3, the groove 12a1 for accommodating the optical fiber 11 is formed in the support body 12. As illustrated in FIGS. 1 and 3, inside the groove 12a1, the resin member 13 covers a boundary between a coating section of the optical fiber 11 and a coating-removed section of the optical fiber 11 and secures the optical fiber 11 to the support body 12.

The feature of the securing structure 10 is that the resin member 13 is spread out of the groove 12a1 partway along the groove 12a1. In order to achieve the feature, in the securing structure 10 in accordance with one or more embodiments, a groove 12a3 intersecting (in one or more embodiments, orthogonal to) the groove 12a1 partway along the groove 12a1 is formed in the support body 12, as illustrated in FIGS. 1 and 2. The ribs 12a2 provided on the both sides of the groove 12a1 partly have respective missing parts partway along the groove 12a1, as illustrated in FIGS. 1 and 3. This allows a liquid resin injected into the groove 12a1 to go into the groove 12a3 partway along the groove 12a1 when the resin member 13 is formed. Thus, the resin member 13 formed by curing the liquid resin is shaped such that the resin member 13 is spread out of the groove 12a1 partway along the groove 12a1, as illustrated FIGS. 1 and 2.

When processing is performed with use of the optical device 1, laser light with which a workpiece is to be irradiated propagates in a forward direction from an optical fiber 11 side to a glass block 15 side, and the light that has been reflected on the workpiece and the like light may propagate in a backward direction from the glass block 15 side to the optical fiber 11 side. In this case, part of the light propagating in the backward direction leaks, in the coating-removed section, from the cladding 11b of the optical fiber 11 into the resin member 13. The light that has leaked, in the coating-removed section, from the cladding 11b of the optical fiber 11 into the resin member 13 may propagate in the resin member 13 formed inside the groove 12a1 and then enter the coating 11c of the optical fiber 11 to cause the coating 11c of the optical fiber 11 to generate heat. In contrast, in the securing structure 10, the resin member 13 is spread out of the groove 12a1 partway along the groove 12a1. This causes part of the light that has leaked, in the coating-removed section, from the cladding 11b of the optical fiber 11 to the resin member 13 to be guided, before entering the coating 11c of the optical fiber 11, to the resin member 13 spread to the outside of the groove 12a1 (specifically, to the groove 12a3). Thus, it is possible to minimize the ratio of the light that enters the coating 11c of the optical fiber 11 in the light that has leaked, in the coating-removed section, from the cladding 11b of the optical fiber 11 to the resin member 13. As a result, it is possible to reduce heat generation which may be caused in the coating 11c of the optical fiber 11 in a case where the light that has leaked, in the coating-removed section, from the cladding 11b of the optical fiber 11 to the resin member 13 enters the coating 11c of the optical fiber 11. Therefore, it is possible to achieve the reliable securing structure 10. As a result, it is possible to achieve the reliable optical device 1.

The resin member 13 may have a refractive index lower than the refractive index of the cladding 11b of the optical fiber 11. This makes it possible to reduce the light that leaks, in the coating-removed section, from the cladding 11b of the optical fiber 11 to the resin member 13. Thus, it is possible to further reduce the intensity of the light entering the coating 11c of the optical fiber 11. As a result, it is possible to further reduce heat generation which may be caused in the coating 11c of the optical fiber 11 in a case where the light that has leaked, in the coating-removed section, from the cladding 11b of the optical fiber 11 to the resin member 13 enters the coating 11c of the optical fiber 11.

Further, the groove 12a1 may be a U-shaped groove as illustrated in FIG. 2. This makes stress that the optical fiber 11 receives from the resin member 13 formed inside the groove 12a1 close to uniform (axially symmetric). As a result, it is possible to prevent degradation in beam quality which may be caused in a case where the optical fiber 11 receives nonuniform (axially asymmetric) stress.

Further, the groove 12a3 may be formed so as to be, as seen in a plan view of the support body 12, linearly symmetric with respect to the groove 12a1, as illustrated in FIG. 1. This makes the stress that the optical fiber 11 receives from the resin member 13 formed inside the grooves 12a1 and 12a3 close to uniform (linearly symmetric). As a result, it is possible to prevent degradation in beam quality which may be caused in a case where the optical fiber 11 receives nonuniform (linearly asymmetric) stress.

Further, a recess 12a4 for regulating the range in which the resin member 13 is spread may be formed at a bottom of the groove 12a1, as illustrated in FIG. 3. This makes it possible to prevent the resin member 13 obtained by curing the liquid resin which has been injected into the groove 12a1 at the formation of the resin member 13, overflowed from the recess 12a4, and entered the vicinity of the flange portion 12b from having an unintended shape (that results in the application of unintended stress to the optical fiber 11).

In one or more embodiments, the groove 12a1 defines a manner in which the resin member 13 spreads. Thus, forming the groove 12a3 intersecting the groove 12a1 allows the resin member 13 to be spread out of the groove 12a1. However, the present invention is not limited to this. For example, the ribs 12a2 may define the manner in which the resin member 13 spreads. In this case, only providing the ribs 12a2 partly having missing parts partway along the groove 12a1, without forming the groove 12a3 intersecting the groove 12a1, allows the resin member 13 to be spread out of the groove 12a1.

### Verification of Effect

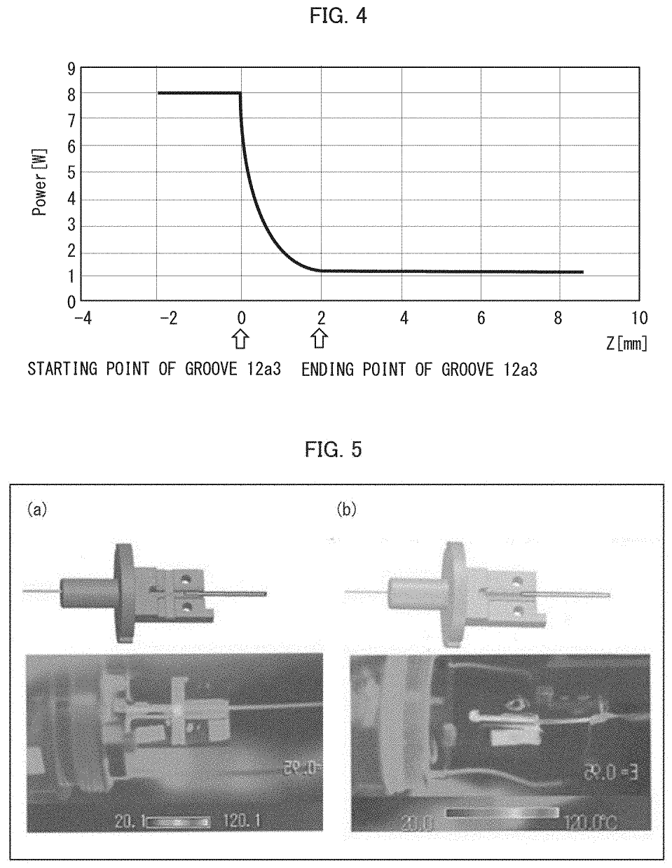

FIG. 4 shows the result of determination, by numerical experiment, of power of the light that, in the securing structure 10, propagates in a backward direction in the resin member 13 formed inside the groove 12a1. FIG. 4 is a graph, along a z-axis illustrated in FIG. 3, showing plots of the power of the light that propagates in a backward direction in the resin member 13 formed inside the groove 12a1. Here, the z-axis is parallel to a light axis of the optical fiber 11. The original point of the z-axis is set at a starting point of the groove 12a3. Note that, in the numerical experiment, it was assumed that the groove 12a3 had a width of 2 mm in a z-axis direction. Note that it was assumed that a refractive index of the cladding 11b of the optical fiber 11 was 1.45, a refractive index of the air was 1, and a refractive index of the resin member 13 was 1.41. In addition, it was assumed that in the section from z=−2 to z=0, the resin member 13 filled in the groove 12a1 with no gap, and in the section from z=0 to z=2, the resin member 13 filled in the grooves 12a1 and 12a3 with no gap.

The graph shown in FIG. 4 reveals the following: in a first section from z=−2 to z=0 in which the resin member 13 is formed only inside the groove 12a1, the power of the light that propagates in a backward direction in the resin member 13 formed inside the groove 12a1 keeps substantially constant; in a second section from z=0 to z=2 in which the resin member 13 is spread out of the groove 12a1, the power of the light that propagates in a backward direction in the resin member 13 formed inside the groove 12a1 is decreased rapidly; and in a third section of z=a value of not less than 2 in which the resin member 13 is formed only inside the groove 12a1, the power of the light that propagates in a backward direction in the resin member 13 formed inside the groove 12a1 keeps substantially constant. The power of the light that, in the third section, propagates in a backward direction in the resin member 13 formed inside the groove 12a1 is approximately one eighth of that of the light that, in the first section, propagates in a backward direction in the resin member 13 formed inside the groove 12a1. This means that the power of light that reaches the coating 11c of the optical fiber 11 is sufficiently low.

(a) of FIG. 5 is a perspective view of a securing structure 10 (Example) and a view illustrating temperature distribution of the securing structure 10 (Example). (b) of FIG. 5 is a perspective view of a securing structure 10 (Comparative Example) that does not include the groove 12a3 so that the resin member 13 is not spread out of the groove 12a1 and a view illustrating temperature distribution of the securing structure 10 (Comparative Example). Both of the temperature distributions are obtained when light propagates in a backward direction in the cladding 11b of the optical fiber 11. As can be seen from the view illustrating the temperature distributions in FIG. 5, in the Comparative Example in which the resin member 13 is not spread out of the groove 12a1, the temperature of the coating 11c of the optical fiber 11 reaches approximately 100° C., whereas in the Example in which the resin member 13 is spread out of the groove 12a1, the temperature of the coating 11c of the optical fiber 11 is suppressed to approximately 40° C. That is, it was confirmed that providing the groove 12a3 and spreading the resin member 13 out of the groove 12a1 could reduce heat generation which was caused in the coating 11c of the optical fiber 11 by the light that had leaked, in the coating-removed section, from the cladding 11b of the optical fiber 11 to the resin member 13.

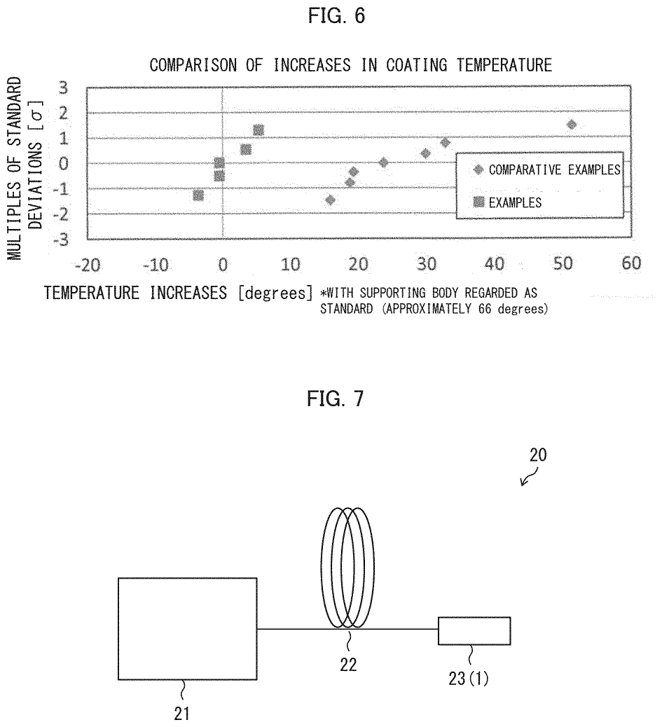

FIG. 6 is a graph showing a correlation between increases in temperatures of the coatings 11c of the optical fibers 11 and deviations of the increases, with respect to the above-described Example of 5 samples and the above-described Comparative Example of 7 samples. Note that in the graph shown in FIG. 6, the horizontal axis indicates differences between the increases in temperatures of the coatings 11c of the optical fibers 11 and the increases in temperatures of the support bodies 12, and the vertical axis indicates multiples of the standard deviations. As can be seen from the graph shown in FIG. 6, in the Comparative Example, the mean value of the increases in temperatures of the coatings 11c is higher by approximately 30° C. than the increase in temperature of the support body 12, whereas in the Example, the mean value of the increases in temperatures of the coatings 11c is approximately equal to the increase in temperature of the support body 12. Further, as can be seen from the graph shown in FIG. 6, in the Comparative Example, variations of the increases in temperatures of the coatings 11c are so large that an extreme increase in temperature which can cause a serious damage in the coating 11c is highly likely to occur, whereas in the Example, variations in the increases in temperatures of the coatings 11c are so small that such an extreme increase in temperature is less likely to occur. That is, it can be seen that the Example are more reliable than the Comparative Example.

### Laser Apparatus

The above-described optical device 1 can be used in a laser apparatus for processing. FIG. 7 is a block diagram illustrating a configuration of such a laser apparatus 20.

The laser apparatus 20 includes a laser light source 21, a delivery fiber 22, and an optical device 23. The laser light source 21 is a component for generating laser light. The laser light source 21 may be a solid laser, a liquid laser, a gas laser, or a fiber laser. The delivery fiber 22 is a component for guiding the laser light generated by the laser light source 21. The delivery fiber 22 may be a single-mode fiber or a multimode fiber. The optical device 23 is a component for irradiating a workpiece W with the light guided by the delivery fiber 22. The above-described optical device 1 can be used as the optical device 23 to achieve a reliable laser apparatus 20.

One or more embodiments of the present invention can also be expressed as follows:

As described above, a securing structure in accordance with one or more embodiments of the present invention includes: an optical fiber; a support body in which a groove for accommodating the optical fiber is formed; and a resin member for covering, inside the groove, a boundary between a coating section of the optical fiber and a coating-removed section of the optical fiber and securing the optical fiber to the support body, the resin member being spread out of the groove partway along the groove.

The above-described configuration makes light that has leaked, in the coating-removed section, from a cladding of the optical fiber to the resin member less likely to enter a coating of the optical fiber in the coating section. Thus, it is possible to reduce heat generation caused in the coating of the optical fiber as compared with a case where the resin member is formed only inside the groove. As a result, it is possible to achieve a reliable securing structure as compared with the case where the resin member is formed only inside the groove.

A securing structure in accordance with one or more embodiments of the present invention employs, in addition to the configuration in accordance with the embodiments described above, a configuration such that another groove intersecting the groove is formed in the support body, and the resin member is spread inside the another groove.

The above-described configuration facilitates spreading the resin member out of the groove partway along the groove in a case where the resin member is formed by curing a liquid resin that has been injected into the groove.

A securing structure in accordance with one or more embodiments of the present invention employs, in addition to the configuration in accordance with the embodiments described above, a configuration such that the another groove is formed so as to be, in a plan view of the support body, linearly symmetric with respect to the groove.

The above-described configuration makes it possible to prevent degradation in beam quality which may be caused by nonuniform stress applied from the resin member to the optical fiber.

A securing structure in accordance with one or more embodiments of the present invention employs, in addition to the configuration in accordance with the embodiments described above, a configuration such that the resin member has a refractive index lower than a refractive index of a cladding of the optical fiber.

The above-described configuration makes it possible to further reduce heat generation caused in the coating of the optical fiber.

A securing structure in accordance with one or more embodiments of the present invention employs, in addition to the configuration in accordance with the embodiments described above, a configuration such that the groove is a U-shaped groove.

The above-described configuration makes it possible to prevent degradation in beam quality which may be caused by nonuniform stress applied from the resin member to the optical fiber.

A securing structure in accordance with one or more embodiments of the present invention employs, in addition to the configuration in accordance with the embodiments described above, a configuration such that a recess for regulating a range in which the resin member is spread is formed at a bottom of the groove.

The above-described configuration makes less likely to occur a situation where a resin member having an unintended shape is formed, and, as a result, unintended stress acts on the optical fiber.

An optical device in accordance with one or more embodiments of the present invention includes the securing structure in accordance with the embodiments described above.

The above-described configuration makes it possible to achieve a more reliable optical device than an optical device including the conventional securing structure.

A laser apparatus in accordance with one or more embodiments of the present invention includes the optical device in accordance with the embodiments described above.

The above-described configuration makes it possible to achieve a more reliable laser apparatus than a laser apparatus including the conventional optical device.

### Supplementary Note

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

1 Optical device

10 Securing structure

11 Optical fiber

11a Core

11b Cladding

11c Coating

12 Support body

12a Base portion

12a1 Groove

12a2 Rib

12a3 groove

12a4 Recess

13 Resin member

14 Large-diameter fiber

15 Glass block

20 Laser apparatus

21 Laser light source

22 Delivery fiber

23 Optical device

1. A securing structure comprising:
an optical fiber;
a support body that comprises a first groove that accommodates the optical fiber; and
a resin member that, inside the first groove:
covers a boundary between a coating section of the optical fiber and a coating-removed section of the optical fiber, and
secures the optical fiber to the support body, wherein
the resin member spreads out of the first groove partway along the first groove.

2. The securing structure according to claim 1, wherein
the support body further comprises a second groove intersecting the first groove in the support body, and
the resin member spreads inside the second groove.

3. The securing structure according to claim 2, wherein the second groove is linearly symmetric with respect to the first groove in a plan view of the support body.

4. The securing structure according to claim 1, wherein the resin member has a refractive index lower than a refractive index of a cladding of the optical fiber.

5. The securing structure according to claim 1, wherein the first groove is U-shaped.

6. The securing structure according to claim 1, wherein a recess that regulates a range in which the resin member spreads is disposed at a bottom of the first groove.

7. An optical device comprising the securing structure according to claim 1.

8. A laser apparatus comprising an optical device that comprises the securing structure according to claim 1.
